(19) United States
(12) Patent Application Publication
(10) Pub. No.: US 2012/0318926 A1
(43) Pub. Date: Dec. 20, 2012

(54) Inflatable airlock

(75) Inventors: Jay Ingham, Las Vegas, NV (US); Eric Haakonstad, Las Vegas, NV (US)

(73) Assignee: Bigelow Aerospace

(21) Appl. No.: 13/507,229

(22) Filed: Jun. 14, 2012

Related U.S. Application Data
(60) Provisional application No. 61/520,775, filed on Jun. 15, 2011.

(51) Int. Cl. B64G 1/64; B64G 1/56

(52) U.S. Cl. 244/159.4

(57) ABSTRACT

An inflatable airlock for use with a spacecraft is disclosed. The airlock has a substantially cylindrical shaped layered shell comprised of an outer meteoroid shield layer, a restraint layer under the meteoroid shield, and an air barrier layer under the restraint layer. There is a door arrangement attached to the airlock and the airlock is adapted to being attached to a spacecraft bulkhead that also includes a door. When inflated, a person can open the spacecraft bulkhead door and pass through from the spacecraft into the airlock or vice versa. When the atmosphere is removed from the airlock, a person can pass from the airlock into space or vice versa.

### CROSS-REFERENCE TO RELAYED APPLICATIONS

This application is a continuation of U.S. Provisional Application No. 61/520,775 filed Jun. 15, 2011, which is hereby incorporated by reference in its entirety.

### FIELD OF THE INVENTION

This invention generally relates to space vehicles and in particular airlocks that are with, or part of, a space vehicle.

### BACKGROUND OF THE INVENTION

Manned spacecraft are being developed to meet the need of space exploration. A variety of technologies are being explored that include inflatable spacecraft.

A typical inflatable spacecraft is launched in a compressed state and expands to a larger volume when deployed. Examples of such spacecraft include U.S. Pat. No. 6,231,010 to Schneider, et al. Expandable spacecraft have the advantage of taking up less space at the time of launch than corresponding solid shelled craft. Once deployed, the expandable spacecraft inflates. The inflation creates a volume that is larger than the inside of a solid shelled craft having the same launch dimensions.

Such a spacecraft would include an airlock for ingress and egress of people and equipment in relation to the internal volume. The airlocks have been developed as hard shelled structures. This imposes a restriction on the size of an airlock that can be launched into space. Furthermore, these solid structures add considerable weight to the spacecraft and impose restrictions on the operability of the spacecraft.

What is needed is an airlock that is not hard shelled to reduce weight and increase the operability of a spacecraft.

### SUMMARY OF THE INVENTION

An inflatable airlock for use with a spacecraft is disclosed. The spacecraft has an internal volume and the inflatable airlock has an enclosure defining an airlock space, the enclosure having a substantially cylindrical shaped layered shell comprised of an outer meteoroid shield layer, a restraint layer under the meteoroid shield, and an air barrier layer under the restraint layer, and one end of the enclosure adapted to attach to a bulkhead of the spacecraft, wherein the bulkhead comprising a door arrangement operable in a closed state and an opened state. There is a door arrangement having a closed state, and an open state and the door arrangement being coupled to the enclosure, wherein the door arrangement in the open state defines a passage into the airlock. There is also a telescoping longeron having a first end attached to the door arrangement and a second end adapted to being attached to the bulkhead of the spacecraft. The telescoping longeron can function to extend the airlock or contract the airlock. A system pressurizes and depressurizes the airlock space and another system is for extending the telescoping longeron from a contracted state to an extended state and contracting the telescoping longeron from an extended state to a contracted state.

### BRIEF DESCRIPTION OF THE DRAWINGS

The invention is generally shown by way of reference to the accompanying drawings in which:

FIG. 1 is an inflatable airlock attached to a spacecraft;

FIG. 2 is another view of an inflatable airlock attached to a spacecraft;

FIG. 3 is a cutaway side view of an inflatable airlock identifying a telescoping longeron in a contracted state; and

FIG. 4 is a cutaway side view of an inflatable airlock identifying a telescoping longeron in an extended state.

### DETAILED DESCRIPTION OF THE INVENTION

The airlock of the present invention can function in basically the same manner as a normal airlock that allows people to pass between the pressurized and vacuum environments without completely venting the interior of the main vehicle.

One advantage of an embodiment of the inflatable airlock is that the inflatable airlock can be packed in a relatively small volume to fit more easily in a launch vehicle. The airlock can be reduced in size both longitudinally and radial.

Since the airlock is inflatable, one embodiment can maintain its pressurized shape without the need for longerons. In this embodiment, the restraint layers would be optimized to take loads that the longerons would normally take in larger human habitable inflatable crafts.

Another embodiment may use longerons to hold the airlock shape in the pre-deployed mode and then the longerons could be situated to support EVAs when there are people outside of the vehicle. This could aide in ingress to an unpressurized airlock.

Another embodiment could use telescoping longerons. Yet another embodiment could use shock absorbing longerons.

Due to the general flexibility of an inflatable airlock, the airlock could be compressed and thereby change the overall shape of the spacecraft to allow for electromagnetic shielding of the spacecraft.

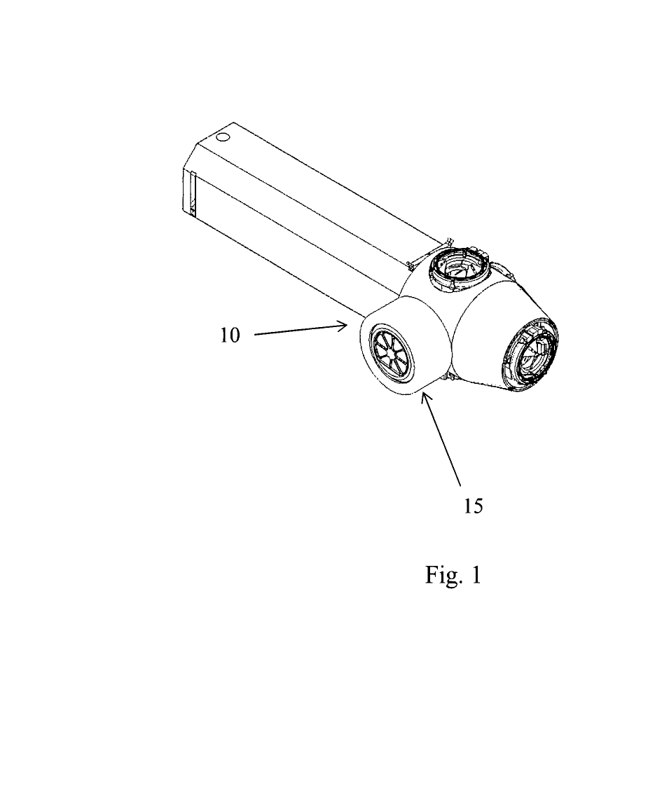

FIG. 1 identifies an inflatable airlock 10. In this embodiment, the shape of the airlock is basically cylindrical. The inflatable portion 15 has many characteristics found in inflatable spacecraft such as U.S. Pat. No. 6,231,010 to Schneider, et al, incorporated herein by reference. For example, an embodiment may have a meteoroid orbital debris (M/OD) shield. The inflatable portion 15 does not have a pressurized atmosphere in this figure. As such, it is collapsed and occupies less volume that when inflated.

In one embodiment there is an outer meteoroid shield layer, a restraint layer under the meteoroid shield, and an air barrier layer under the restraint layer. The inflatable airlock 10 can also be comprised of bulkheads and hatches. There can also be clevis type restraint layer attachments.

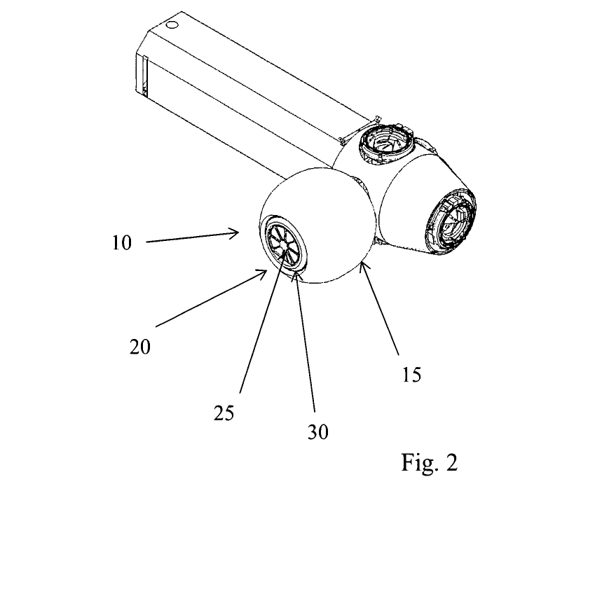

Turning to FIG. 2, the inflatable portion 15 is now inflated with a pressurized interior. The increased size is visible. There is a door arrangement 20 that comprises a door 25 that can function in either an opened or closed state. The door arrangement includes a frame 30 that can attach to a longeron.

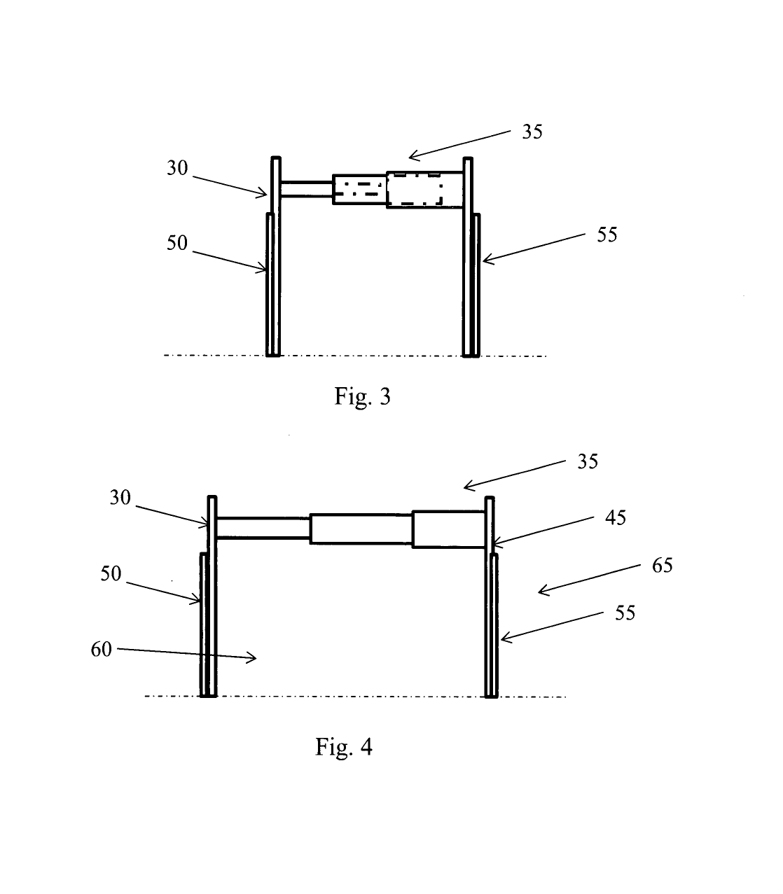

FIG. 3 shows a partial cross sectional view of an embodiment of the airlock utilizing a telescoping longeron 35 disposed within the airlock 10. The telescoping longeron 35 is shown in the contracted state. The longeron 35 is attached to the frame 30 of a door arrangement and also to the bulkhead 45 of the spacecraft. Also shown are the airlock door 50 and the bulkhead door 55.

Turning to FIG. 4, the telescoping longeron 35 is in the extended state. The longeron 35 can be extended and contracted using systems including pneumatic techniques, pulleys, or other mechanical means. The airlock space 60 can contain an atmosphere. The atmosphere can be introduced or extracted by any number of means including pumps. In one stage of operation the atmosphere in the airlock space 60 is equalized with the atmosphere in the spacecraft internal volume 65. In this fashion a person could transfer between the airlock and the spacecraft or vice versa. With the airlock door and bulkhead door close, the atmosphere could be removed. Then a person could exit the airlock door into space.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. An inflatable airlock for use with a spacecraft, the spacecraft having an internal volume, the inflatable airlock comprising:
an enclosure defining an airlock space, the enclosure having a substantially cylindrical shaped layered shell comprised of an outer meteoroid shield layer, a restraint layer under the meteoroid shield, and an air barrier layer under the restraint layer, and one end of the enclosure adapted to attach to a bulkhead of the spacecraft, wherein the bulkhead comprising a door arrangement operable in a closed state and an opened state;
a door arrangement having a closed state, and an open state and the door arrangement being coupled to the enclosure, wherein the door arrangement in the open state defines a passage into the airlock;
a telescoping longeron having a first end attached to the door arrangement and a second end adapted to being attached to the bulkhead of the spacecraft;
a system for pressurizing and depressurizing the airlock space; and
a system for extending the telescoping longeron from a contracted state to an extended state and contracting the telescoping longeron from an extended state to a contracted state;
wherein the bulkhead door arrangement in the opened state forms passage between the airlock space and the spacecraft internal volume.

2. An inflatable airlock for use with a spacecraft, the spacecraft having an internal volume, the inflatable airlock comprising:
an enclosure defining an airlock space, the enclosure having a substantially cylindrical shaped layered shell comprised of an outer meteoroid shield layer, a restraint layer under the meteoroid shield, and an air barrier layer under the restraint layer, and one end of the enclosure adapted to attach to a bulkhead of the spacecraft, wherein the bulkhead comprising a door arrangement operable in a closed state and an opened state;
a door arrangement having a closed state, and an open state and the door arrangement being coupled to the enclosure, wherein the door arrangement in the open state defines a passage into the airlock;
a longeron having a first end attached to the door arrangement and a second end adapted to being attached to the bulkhead of the spacecraft;
a system for pressurizing and depressurizing the airlock space; and
wherein the bulkhead door arrangement in the opened state forms passage between the airlock space and the spacecraft internal volume.

3. An inflatable airlock for use with a spacecraft, the spacecraft having an internal volume, the inflatable airlock comprising:
an enclosure defining an airlock space, the enclosure having a substantially cylindrical shaped layered shell comprised of an outer meteoroid shield layer, a restraint layer under the meteoroid shield, and an air barrier layer under the restraint layer, and one end of the enclosure adapted to attach to a bulkhead of the spacecraft, wherein the bulkhead comprising a door arrangement operable in a closed state and an opened state;
a door arrangement having a closed state, and an open state and the door arrangement being coupled to the enclosure, wherein the door arrangement in the open state defines a passage into the airlock;
a system for pressurizing and depressurizing the airlock space; and
wherein the bulkhead door arrangement in the opened state forms passage between the airlock space and the spacecraft internal volume.
